(19) United States
(12) Patent Application Publication
(10) Pub. No.: US 2026/0367235 A1
(43) Pub. Date: Nov. 19, 2026

(54) APPARATUS AND METHOD FOR MONITORING OF INSIDE OF VEHICLE

(71) Applicant: HL Klemove Corp., Incheon (KR)

(72) Inventor: Daegyeong KIM, Incheon (KR)

(73) Assignee: HL Klemove Corp., Incheon (KR)

(21) Appl. No.: 19/644,149

(22) Filed: Apr. 10, 2026

(30) Foreign Application Priority Data
May 15, 2025 (KR) 10-2025-0063192

(51) Int. Cl. G01S 13/04; B60R 22/48; B60R 25/102; B60R 25/31; B60R 25/34

(52) U.S. Cl. CPC G01S 13/04; B60R 22/48; B60R 25/102; B60R 25/31; B60R 25/34

(57) ABSTRACT

The present disclosure relates to an apparatus and a method for monitoring an inside of a vehicle. The apparatus includes one or more processors and a memory storing one or more programs executed by the one or more processors, and the one or more processors detect, in real time, whether an infant is present inside the vehicle, whether an intrusion into the vehicle interior is detected, and whether a seat belt is worn, based on sensing data acquired from a radar sensor provided at a room-mirror coupling portion of the vehicle. Various other embodiments are also possible.

### CROSS-REFERENCE TO RELATED APPLICATION

The present application claims priority under 35 U.S.C. § 119(a) to Korean patent application number 10-2025-0063192 filed on May 15, 2025, in the Korean Intellectual Property Office, the entire disclosure of which is incorporated by reference herein.

### BACKGROUND

### 1. Technical Field

The present disclosure relates to an apparatus and a method for monitoring an inside of a vehicle.

### 2. Related Art

In recent years, various incidents have increasingly occurred when a caregiver leaves a vehicle while a child or a pet remains inside the vehicle. In addition, as vehicles become increasingly prevalent, crimes involving vehicle theft and damage to a vehicle exterior have also been steadily increasing. Furthermore, accidents caused by occupants failing to wear seat belts while the vehicle is in motion continue to occur.

In order to address these issues, conventional techniques have detected the presence of occupants inside a vehicle by configuring a detection sensor as a thermal sensor or a pressure sensor. Conventional techniques have also configured a detection sensor as an accelerometer or a camera to detect an impact applied to the vehicle from the outside in order to prevent vehicle intrusion or theft. In addition, conventional techniques have confirmed whether a seat belt is worn by detecting whether a person is seated on a chair using a pressure sensor provided in the seat and determining the fastening state of a seat belt buckle.

Accordingly, in order to detect the inside of a vehicle, conventional techniques required various sensors to be provided and the inside of the vehicle to be detected by analyzing sensing data obtained from each sensor. However, when various types of sensors operate, a problem arises in that battery consumption of the vehicle increases.

### SUMMARY

Exemplary embodiments of the present disclosure are directed to providing an apparatus and a method for monitoring an inside of a vehicle, in which a radar sensor is installed at a room-mirror coupling portion and the radar sensor is used to monitor the inside of the vehicle in real time, thereby addressing the above-described conventional problems.

An apparatus for monitoring an inside of a vehicle according to an exemplary embodiment of the present disclosure includes one or more processors and a memory storing one or more programs executed by the one or more processors. The one or more processors may detect, in real time, whether an infant is present inside the vehicle, whether an intrusion into the vehicle interior is detected, and whether a seat belt is worn, based on sensing data acquired from a radar sensor provided at a room-mirror coupling portion of the vehicle.

In addition, the one or more processors may activate an infant-presence detection mode to check whether an infant is present inside the vehicle when an ignition of the vehicle is turned off, and may detect whether an infant is present inside the vehicle by analyzing the sensing data.

In addition, the one or more processors may output a notification when an infant is present inside the vehicle.

In addition, the one or more processors may transmit a notification message to a driver terminal when an infant is present inside the vehicle.

In addition, the one or more processors may activate an intrusion detection mode to check whether an intrusion into the vehicle interior is detected when an ignition of the vehicle is turned off, and may detect whether an intrusion into the vehicle interior is detected by analyzing the sensing data.

In addition, the one or more processors may calculate an impact time, an impact magnitude, and a speed at which an impact occurs in the vehicle based on acceleration data, accumulate the speed for a threshold time to calculate motion or tilt of the vehicle, and detect whether an intrusion into the vehicle interior is detected.

In addition, the one or more processors may output a notification when an intrusion into the vehicle interior is detected.

In addition, the one or more processors may transmit a notification message to a driver terminal when an intrusion into the vehicle interior is detected.

In addition, the one or more processors may activate a seat-belt-wearing detection mode to check whether a seat belt is worn when an ignition of the vehicle is turned on, and may detect whether the seat belt is worn by analyzing the sensing data.

In addition, the one or more processors may output a notification when a failure to wear the seat belt is detected while a speed of the vehicle is equal to or greater than a threshold.

Furthermore, a method for monitoring an inside of a vehicle according to an exemplary embodiment of the present disclosure, the method performed by an apparatus including one or more processors and a memory storing one or more programs executed by the one or more processors may include acquiring sensing data from a radar sensor provided at a room-mirror coupling portion of a vehicle; and detecting, in real time, whether an infant is present inside the vehicle, whether an intrusion into the vehicle interior is detected, and whether a seat belt is worn, based on the sensing data.

In addition, the acquiring of the sensing data may include activating an infant-presence detection mode to check whether an infant is present inside the vehicle when an ignition of the vehicle is turned off and acquiring the sensing data.

In addition, the method may further include outputting a notification when an infant is present inside the vehicle by analyzing the sensing data.

In addition, the method may further include transmitting a notification message to a driver terminal when an infant is present inside the vehicle.

In addition, the acquiring of the sensing data may include activating an intrusion detection mode to check whether an intrusion into the vehicle interior is detected when an ignition of the vehicle is turned off and acquiring the sensing data.

In addition, the detecting in real time may include calculating an impact time, an impact magnitude, and a speed at which an impact occurs in the vehicle based on acceleration data, accumulating the speed for a threshold time to calculate motion or tilt of the vehicle, and detecting in real time whether an intrusion into the vehicle interior is detected.

In addition, the method may further include outputting a notification when an intrusion into the vehicle interior is detected by analyzing the sensing data.

In addition, the method may further include transmitting a notification message to a driver terminal when an intrusion into the vehicle interior is detected.

In addition, the acquiring of the sensing data may include activating a seat-belt-wearing detection mode to check whether a seat belt is worn when an ignition of the vehicle is turned on and acquiring the sensing data.

In addition, the acquiring of the sensing data may further include outputting a notification when a failure to wear the seat belt is detected while a speed of the vehicle is equal to or greater than a threshold.

As described above, the apparatus and method for monitoring an inside of a vehicle according to the present disclosure provide an effect of enabling a uniform check of the state of all seats located inside the vehicle by installing a radar sensor at a room-mirror coupling portion and monitoring, in real time, the inside of the vehicle using the radar sensor.

### BRIEF DESCRIPTION OF THE DRAWINGS

FIG. 1 is a block diagram illustrating main components of an apparatus for monitoring an inside of a vehicle according to an exemplary embodiment of the present disclosure.

FIG. 2 is a view illustrating an example of a location at which a radar sensor for monitoring an inside of a vehicle is provided according to an exemplary embodiment of the present disclosure.

FIG. 3 is a flowchart illustrating detection of whether an infant is present inside a vehicle according to an exemplary embodiment of the present disclosure.

FIG. 4 is a flowchart illustrating detection of an intrusion into a vehicle interior according to an exemplary embodiment of the present disclosure.

FIG. 5 is a flowchart illustrating detection of whether a passenger inside a vehicle has worn a seat belt according to an exemplary embodiment of the present disclosure.

### DETAILED DESCRIPTION OF THE EMBODIMENTS

Hereinafter, specific embodiments according to an embodiment of the present disclosure will be described with reference to the drawings. The following detailed description is provided to aid in a comprehensive understanding of the methods, apparatuses, and/or systems described herein. However, these are merely examples, and the present disclosure is not limited thereto.

In describing the embodiments of the present disclosure, detailed descriptions of related known technologies will be omitted when it is determined that such descriptions may unnecessarily obscure the gist of the embodiments. The terms described below are defined in consideration of the functions of the present disclosure and may vary depending on the intention or custom of the user or operator, or other practices. Therefore, the definitions of the terms should be interpreted based on the overall contents of this specification. The terminology used in the detailed description is intended merely to describe exemplary embodiments and should not be construed as limiting. Unless clearly stated otherwise, expressions in the singular form include the plural form as well. In the present description, expressions such as “comprise,” “include,” or “provide” are intended to indicate the presence of stated features, numbers, steps, operations, elements, components, or combinations thereof, and should not be interpreted as excluding the possibility of the presence or addition of one or more other features, numbers, steps, operations, elements, components, or combinations thereof. In addition, terms such as “unit,” “part,” “module,” and “block,” as used in the present specification, refer to functional elements configured to perform at least one function or operation and may be implemented in hardware, in software, or in a combination of hardware and software.

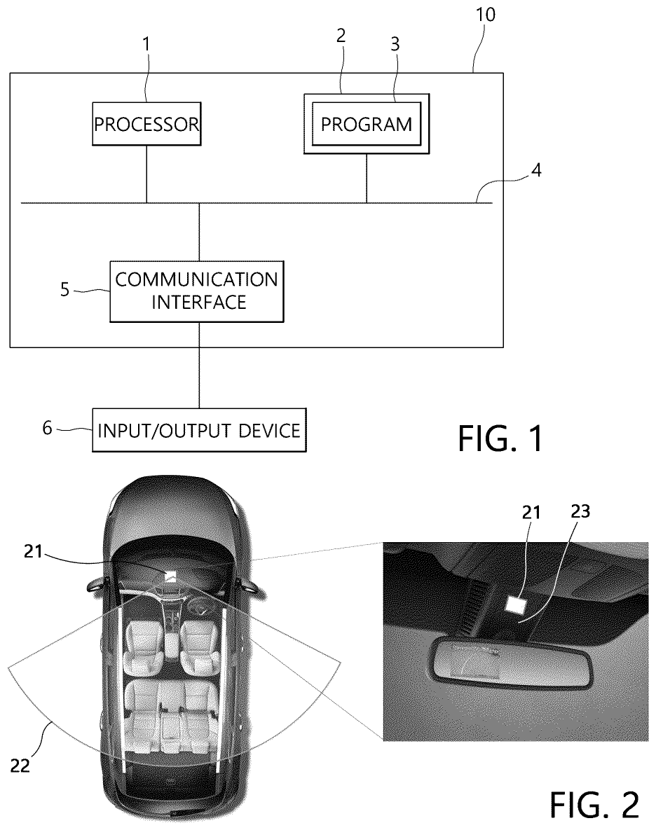

FIG. 1 is a block diagram illustrating main components of an apparatus for monitoring an inside of a vehicle according to an exemplary embodiment of the present disclosure.

Referring to FIG. 1, an apparatus 10 according to the present disclosure may be a computing apparatus such as an electronic device for detecting an inside of a vehicle by using sensing data acquired from a radar sensor provided at a room-mirror coupling portion of the vehicle. The apparatus 10 may include a processor 1, a computer-readable storage medium 2, a program 3, a communication bus 4, and a communication interface 5. The apparatus 10 may further include one or more input/output devices 6 connected through the communication interface 5.

The processor 1 may cause the apparatus 10 to operate according to exemplary embodiments described below. For example, the processor 1 may execute one or more programs 3 stored in the computer-readable storage medium 2. The one or more programs 3 may include one or more computer-executable instructions, and when executed by the processor 1, the computer-executable instructions may be configured to cause the apparatus 10 to perform operations according to the exemplary embodiments.

The communication bus 4 interconnects various components of the apparatus 10, including the processor 1, the computer-readable storage medium 2, and the communication interface 5.

The apparatus 10 may include one or more communication interfaces 5 that provide an interface for one or more input/output devices 6. The communication interface 5 is connected to the communication bus 4. The input/output device 6 may be connected to other components of the apparatus 10 through the communication interface 5. Exemplary input/output devices 6 may include various types of input devices such as a touch input device (e.g., a touchpad or a touchscreen), a voice or sound input device, sensors including a radar sensor and an inertial sensor, and/or a camera, and output devices such as a display device, a speaker, and a light. The input/output device 6 may be included inside the apparatus 10 as one component constituting the apparatus 10, or may be connected as a separate device from the apparatus 10.

The processor 1 may be communicatively connected, through the communication interface 5, to at least one electronic control unit (ECU) that controls other systems mounted in the vehicle (hereinafter referred to as “vehicle internal systems”). The vehicle internal systems may include, for example, a vehicle cluster, an infotainment system, a warning signal output device, and a lighting system. In addition, the at least one electronic control unit may be communicatively connected to a user terminal (such as a smartphone) or a vehicle key registered with the vehicle.

In addition, the processor 1 may communicate with at least one electronic control unit of the vehicle internal systems to output a notification when the processor 1 determines that at least one situation occurs among a case in which an infant is present inside the vehicle, a case in which an intrusion into the vehicle interior is detected, and a case in which a passenger's failure to wear a seat belt is detected. The at least one electronic control unit may output the notification by controlling each connected vehicle internal system, such as a light, a speaker, a display, or a warning lamp of the vehicle. In addition, the at least one electronic control unit may output the notification through a user terminal (such as a smartphone) or a vehicle key registered with the vehicle.

The communication interface 5 may perform wired communication such as Controller Area Network (CAN) communication, Local Interconnect Network (LIN) communication, Automotive Audio Bus (A2B) communication, Ethernet communication, a local area network (LAN), a wide area network (WAN), or power line communication, and may also perform wireless communication such as 5th generation (5G) communication, long term evolution-advanced (LTE-A), long term evolution (LTE), Wi-Fi (wireless fidelity), or Bluetooth.

More specifically, when it is confirmed that the vehicle ignition is turned off, the processor 1 activates an infant-presence detection mode. The processor 1 receives and analyzes sensing data acquired from the radar sensor 21.

The processor 1 determines, based on the analysis result of the sensing data, whether a passenger is detected inside the vehicle. If the determination result indicates that no passenger is detected inside the vehicle, the processor 1 determines whether a length of time during which no passenger has been detected exceeds a threshold time. If the length of time during which no passenger has been detected exceeds the threshold time, the processor 1 deactivates the infant-presence detection mode, and if the length of time during which no passenger has been detected does not exceed the threshold time, the processor 1 rechecks whether a passenger is detected inside the vehicle.

When a passenger is detected inside the vehicle, the processor 1 determines whether the detected passenger is an infant. If the passenger inside the vehicle is determined to be an infant, the processor 1 outputs a notification indicating that an infant is present inside the vehicle. To this end, the processor 1 may output the notification by using a light of the vehicle or the like. In addition, the processor 1 may transmit a message indicating that an infant is present inside the vehicle to a driver terminal (not shown) connected to the vehicle. When it is confirmed that the vehicle ignition is turned off, the processor 1 activates an intrusion detection mode. The processor 1 receives and analyzes sensing data acquired from the radar sensor 21.

More specifically, the processor 1 may analyze the sensing data to determine movement of an object inside or outside the vehicle by calculating a distance to the object, a speed of the object, and the like.

When an object is detected inside or outside the vehicle based on the analysis result of the sensing data, the processor 1 activates a sensor, such as an inertial sensor (not shown) capable of detecting motions or tilts such as vibration, impact, or tilting occurring in the vehicle, and detects vehicle motion.

The processor 1 determines whether a notification is required based on the detection of the vehicle motion.

More specifically, the processor 1 calculates a peak impact magnitude based on a magnitude difference between a maximum value and a minimum value of acceleration data, and calculates an impact time that has occurred in the vehicle by using a time difference. The processor 1 may calculate a final impact magnitude that has occurred in the vehicle by multiplying the calculated peak impact magnitude by the calculated impact time, and determine that a notification is required when the final impact magnitude exceeds a threshold.

The processor 1 accumulates acceleration data to determine a magnitude of change in speed, and calculates vibration occurring in the vehicle when the magnitude of change continuously occurs for a threshold time. The processor 1 may determine that a notification is required when the calculated vibration exceeds a threshold.

The processor 1 calculates vehicle motion or vehicle tilt by accumulating acceleration. The processor 1 may compare vehicle motion or tilt at a time when the vehicle ignition is turned off with the calculated motion or tilt, and determine that a notification is required when a change equal to or greater than a threshold is identified. In addition, the processor 1 may store the calculated vehicle speed and motion.

The processor 1 outputs a notification by using a light, a speaker, or the like of the vehicle when it is determined that the notification is required. In addition, the processor 1 may transmit a message indicating that an intrusion has occurred inside the vehicle to a driver terminal connected to the vehicle.

When it is confirmed that the vehicle ignition is turned on, the processor 1 activates a seat-belt-wearing detection mode. The processor 1 receives and analyzes sensing data acquired from the radar sensor 21. Through this, the processor 1 can determine whether a passenger is present inside the vehicle.

The processor 1 determines whether the driving speed of the vehicle is equal to or greater than a threshold speed. If the driving speed of the vehicle is less than the threshold speed, the processor 1 may continuously monitor the driving speed of the vehicle. When the driving speed of the vehicle is equal to or greater than the threshold speed, the processor 1 determines whether a notification is required.

More specifically, the processor 1 receives sensing data regarding whether a seat belt is worn through communication with a sensor that detects a seat-belt-wearing state. The processor may determine whether the seat belt is worn through internal sensor or logic that stored in a memory 2. When it is determined that a passenger inside the vehicle is not wearing a seat belt, the processor 1 determines that a notification is required and outputs the notification.

FIG. 2 is a view illustrating an example of a location at which a radar sensor for monitoring an inside of a vehicle is provided according to an exemplary embodiment of the present disclosure.

Referring to FIG. 2, the radar sensor 21 acquires sensing data within a sensing region 22. At this time, the radar sensor 21 is provided at a room-mirror coupling portion 23 and may acquire sensing data for all areas inside the vehicle except for areas that cannot be detected due to headrests of seats installed in the vehicle. In addition, since the radar sensor 21 is provided at the room-mirror coupling portion 23 and is positioned at an upper portion of the vehicle, the radar sensor 21 may acquire sensing data regarding movements occurring inside the vehicle as well as movements at a door or a window of the vehicle.

Since most vehicles are equipped with a room mirror and it is not possible to place objects at the room-mirror coupling portion 23, the radar sensor 21 can operate in various situations. In addition, because no separate sensor needs to be additionally provided, a cost-reduction effect can be achieved.

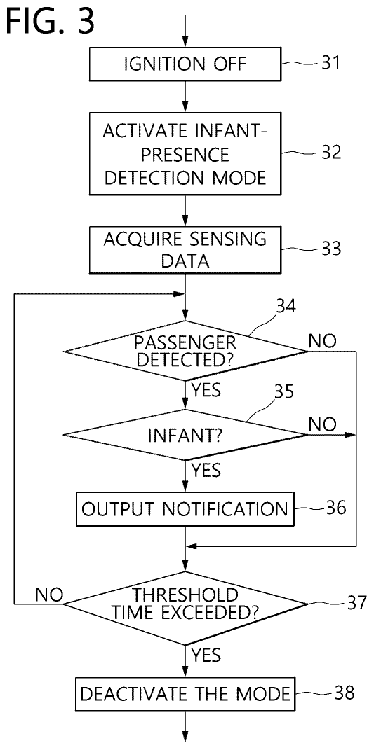

FIG. 3 is a flowchart illustrating detection of whether an infant is present inside a vehicle according to an exemplary embodiment of the present disclosure.

Referring to FIG. 3, when it is confirmed that the vehicle ignition is turned off (31), the processor 1 activates an infant-presence detection mode (32). The processor 1 receives and analyzes sensing data acquired from the radar sensor 21 (33).

The processor 1 determines, based on the analysis result of the sensing data, whether a passenger is detected inside the vehicle (34). If the determination result indicates that no passenger is detected inside the vehicle (34), the processor 1 determines whether a length of time during which no passenger has been detected exceeds a threshold time (37). If the length of time during which no passenger has been detected exceeds the threshold time, the processor 1 deactivates the infant-presence detection mode (38), and if the length of time during which no passenger has been detected does not exceed the threshold time, the processor 1 rechecks whether a passenger is detected inside the vehicle (34).

When a passenger is detected inside the vehicle, the processor 1 determines whether the detected passenger is an infant (35). If it is determined that the passenger inside the vehicle is an infant, the processor 1 outputs a notification indicating that an infant is present inside the vehicle (36). To this end, the processor 1 may output the notification by using a light of the vehicle or the like. In addition, the processor 1 may transmit a message indicating that an infant is present inside the vehicle to a driver terminal (not shown) connected to the vehicle.

If the detected passenger is not an infant, the processor 1 checks whether a threshold time has elapsed after the passenger is detected inside the vehicle (37) to deactivate the infant-presence detection mode (38), or re-checks whether a passenger is detected inside the vehicle (34).

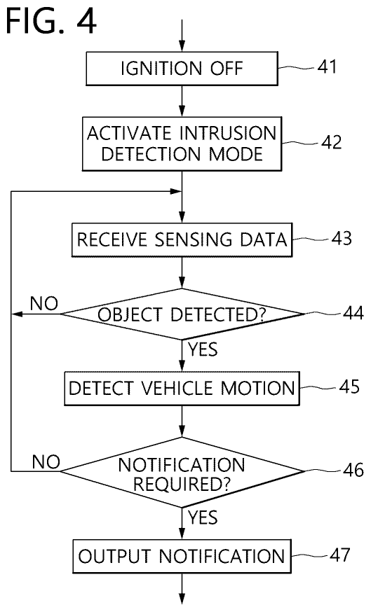

FIG. 4 is a flowchart illustrating detection of an intrusion into a vehicle interior according to an exemplary embodiment of the present disclosure.

Referring to FIG. 4, when it is confirmed that the vehicle ignition is turned off (41), the processor 1 activates an intrusion detection mode (42). The processor 1 receives and analyzes sensing data acquired from the radar sensor 21 (43).

More specifically, the processor 1 may analyze the sensing data to determine movement of an object inside or outside the vehicle by calculating a distance to the object, a speed of the object, and the like.

When an object is detected (44) inside or outside the vehicle based on the analysis result of the sensing data, the processor 1 activates a sensor, such as an inertial sensor (not shown) capable of detecting motions or tilts such as vibration, impact, or tilting occurring in the vehicle, and detects vehicle motion (45).

The processor 1 determines whether a notification is required based on the detection of the vehicle motion (46).

More specifically, the processor 1 calculates a peak impact magnitude based on a magnitude difference between a maximum value and a minimum value of acceleration data, and calculates an impact time that has occurred in the vehicle by using a time difference. The processor 1 may calculate a final impact magnitude that has occurred in the vehicle by multiplying the calculated peak impact magnitude by the calculated impact time, and determine that a notification is required when the final impact magnitude exceeds a threshold (46).

The processor 1 accumulates acceleration data to determine a magnitude of change in speed, and calculates vibration occurring in the vehicle when the magnitude of change continuously occurs for a threshold time. The processor 1 may determine that a notification is required when the calculated vibration exceeds a threshold (46).

The processor 1 calculates vehicle motion or vehicle tilt by accumulating acceleration. The processor 1 may compare vehicle motion or tilt at a time when the vehicle ignition is turned off with the calculated motion or tilt, and determine that a notification is required when a change equal to or greater than a threshold is identified (46). In addition, the processor 1 may store the calculated vehicle speed and motion.

When it is determined that a notification is required, the processor 1 outputs the notification by using a light, a speaker, or the like of the vehicle (47). In addition, the processor 1 may transmit a message indicating that an intrusion has occurred inside the vehicle to a driver terminal connected to the vehicle.

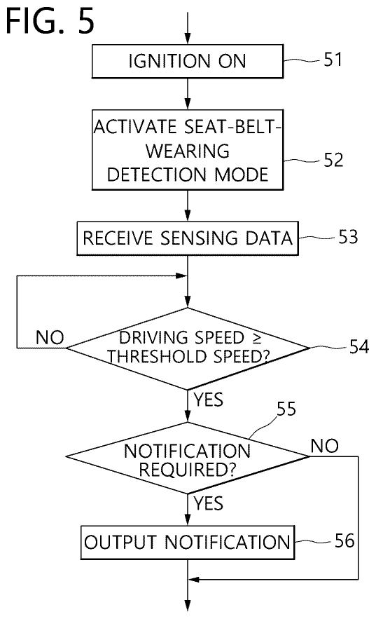

FIG. 5 is a flowchart illustrating detection of whether a passenger inside a vehicle has worn a seat belt according to an exemplary embodiment of the present disclosure.

Referring to FIG. 5, when it is confirmed that the vehicle ignition is turned on (51), the processor 1 activates a seat-belt-wearing detection mode (52). The processor 1 receives and analyzes sensing data acquired from the radar sensor 21 (53). Through this, the processor 1 can determine whether a passenger is present inside the vehicle.

The processor 1 determines whether the driving speed of the vehicle is equal to or greater than a threshold speed (54). If the driving speed of the vehicle is less than the threshold speed, the processor 1 may continuously monitor the driving speed of the vehicle. When the driving speed of the vehicle is equal to or greater than the threshold speed, the processor 1 determines whether a notification is required (55).

More specifically, the processor 1 receives sensing data regarding whether a seat belt is worn through communication with a sensor that detects a seat-belt-wearing state. When it is determined that a passenger inside the vehicle is not wearing a seat belt, the processor 1 determines that a notification is required and outputs the notification (56).

While the present disclosure has been described in detail with reference to representative embodiments, it will be understood by those skilled in the art that various modifications and equivalent other embodiments may be possible based on the present disclosure. Accordingly, the true technical scope of the present disclosure should be defined by the spirit of the appended claims.

What is claimed is:

1. An apparatus, comprising:
a radar sensor installed at a room-mirror coupling portion of a vehicle;
one or more processors; and
a memory storing one or more programs executed by the one or more processors,
wherein the one or more processors are configured to detect, in real time, whether an infant is present inside the vehicle, whether an intrusion into the vehicle interior is detected, or whether a seat belt is worn, based on sensing data acquired from the radar sensor.

2. The apparatus of claim 1, wherein the one or more processors are configured to activate an infant-presence detection mode to check whether an infant is present inside the vehicle when an ignition of the vehicle is turned off, and to detect whether an infant is present inside the vehicle by analyzing the sensing data.

3. The apparatus of claim 2, wherein the one or more processors are configured to output a notification when an infant is present inside the vehicle.

4. The apparatus of claim 3, wherein the one or more processors are configured to transmit a notification message to a driver terminal when an infant is present inside the vehicle.

5. The apparatus of claim 1, wherein the one or more processors are configured to activate an intrusion detection mode to check whether an intrusion into the vehicle interior is detected when an ignition of the vehicle is turned off, and to detect whether an intrusion into the vehicle interior is detected by analyzing the sensing data.

6. The apparatus of claim 5, wherein the one or more processors are configured to calculate an impact time, an impact magnitude, and a speed at which an impact occurs in the vehicle based on acceleration data, to accumulate the speed for a set time to calculate motion or tilt of the vehicle, and to detect whether an intrusion into the vehicle interior is detected.

7. The apparatus of claim 6, wherein the one or more processors are configured to output a notification when an intrusion into the vehicle interior is detected.

8. The apparatus of claim 7, wherein the one or more processors are configured to transmit a notification message to a driver terminal when an intrusion into the vehicle interior is detected.

9. The apparatus of claim 1, wherein the one or more processors are configured to activate a seat-belt-wearing detection mode to check whether a seat belt is worn when an ignition of the vehicle is turned on, and to detect whether the seat belt is worn by analyzing the sensing data.

10. The apparatus of claim 9, wherein the one or more processors are configured to output a notification when a failure to wear the seat belt is detected while a speed of the vehicle is equal to or greater than a threshold.

11. A method performed by an apparatus comprising one or more processors and a memory storing one or more programs executed by the one or more processors, the method comprising:
acquiring sensing data from a radar sensor provided at a room-mirror coupling portion of a vehicle; and
detecting, in real time, whether an infant is present inside the vehicle, whether an intrusion into the vehicle interior is detected, or whether a seat belt is worn, based on the sensing data.

12. The method of claim 11, wherein the acquiring of the sensing data comprises activating an infant-presence detection mode to check whether an infant is present inside the vehicle when an ignition of the vehicle is turned off and acquiring the sensing data.

13. The method of claim 12, further comprising outputting a notification when an infant is present inside the vehicle by analyzing the sensing data.

14. The method of claim 13, further comprising transmitting a notification message to a driver terminal when an infant is present inside the vehicle.

15. The method of claim 11, wherein the acquiring of the sensing data comprises activating an intrusion detection mode to check whether an intrusion into the vehicle interior is detected when an ignition of the vehicle is turned off and acquiring the sensing data.

16. The method of claim 15, wherein the detecting in real time comprises calculating an impact time, an impact magnitude, and a speed at which an impact occurs in the vehicle based on acceleration data, accumulating the speed for a set time to calculate motion or tilt of the vehicle, and detecting in real time whether an intrusion into the vehicle interior is detected.

17. The method of claim 16, further comprising outputting a notification when an intrusion into the vehicle interior is detected by analyzing the sensing data.

18. The method of claim 17, further comprising transmitting a notification message to a driver terminal when an intrusion into the vehicle interior is detected.

19. The method of claim 11, wherein the acquiring of the sensing data comprises activating a seat-belt-wearing detection mode to check whether a seat belt is worn when an ignition of the vehicle is turned on and acquiring the sensing data.

20. The method of claim 19, further comprising outputting a notification when a failure to wear the seat belt is detected while a speed of the vehicle is equal to or greater than a threshold.
